(19) United States
(12) Patent Application Publication
(10) Pub. No.: US 2025/0220481 A1
(43) Pub. Date: Jul. 3, 2025

(54) METHODS AND APPARATUSES FOR MEASUREMENT ENHANCEMENT

(71) Applicant: LENOVO (BEIJING) LIMITED, Beijing (CN)

(72) Inventors: Jing Han, Beijing (CN); Min Xu, Beijing (CN); Lianhai Wu, Beijing (CN); Haiming Wang, Beijing (CN); Jie Hu, Beijing (CN); Ran Yue, Beijing (CN)

(21) Appl. No.: 18/852,787

(22) PCT Filed: Apr. 1, 2022
(86) PCT No.: PCT/CN2022/084808

§ 371 Date: Sep. 30, 2024

(51) Int. Cl. H04W 24/10; H04W 36/00; H04W 36/32

(52) U.S. Cl. CPC H04W 24/10; H04W 36/0058; H04W 36/00835; H04W 36/324

(57) ABSTRACT

The present application relates to methods and apparatuses for measurement enhancement for UAVUE mobility. One embodiment of the present disclosure provides a UE, which includes: a processor; and a transceiver coupled with the processor, and the transceiver is configured to: receive a first configuration for triggering a measurement reporting procedure for one or more cells, wherein the first configuration includes one of the following: a first indication associated with triggering the measurement reporting procedure when a second configuration for multiple cell measurement report trigger extension is available; a second indication associated with an update of triggered cells measurement results; or a third indication associated with a reference area of the UE; and initiate the measurement reporting procedure and transmit a measurement report.

### TECHNICAL FIELD

The present disclosure relates to wireless communications, and especially to methods and apparatuses for measurement enhancement for unmanned aerial vehicle (UAV) user equipment (UE) mobility.

### BACKGROUND OF THE INVENTION

During UAV UE mobility, for example, a handover procedure, a base station (BS) may configure one or more measurement conditions for the UAV UE to trigger a measurement reporting procedure. When at least one of the one or more measurement conditions is met, the UAV UE may transmit the measurement report to the BS, which may help the BS to determine to which neighbor cell the UAV UE should perform a handover procedure.

That is, the measurement report is important during UAV UE mobility, and it is described herein how to provide solutions for measurement enhancement for UAV UE mobility.

### SUMMARY

One embodiment of the present disclosure provides a UE, which includes: a processor; and a transceiver coupled with the processor, and the transceiver is configured to: receive a first configuration for triggering a measurement reporting procedure for one or more cells, wherein the first configuration includes one of the following: a first indication associated with triggering the measurement reporting procedure when a second configuration for multiple cell measurement report trigger extension is available; a second indication associated with an update of triggered cells measurement results; or a third indication associated with a reference area of the UE; and initiate the measurement reporting procedure and transmit a measurement report.

In some embodiments, initiating the measurement reporting procedure includes: initiating the measurement reporting procedure when a first cell as a first one which fulfills an entry condition of a configured measurement trigger event according to the first indication, wherein the measurement report of the measurement reporting procedure includes a measurement result of the first cell.

In some embodiments, initiating the measurement reporting procedure includes: initiating the measurement reporting procedure periodically according to the first indication after the measurement reporting procedure is initiated based on the second configuration for multiple cell measurement report trigger extension.

In some embodiments, initiating the measurement reporting procedure includes: using a timer for periodically initiating the measurement report according to the first indication.

In some embodiments, the processor is further configured to: disable the second configuration for multiple cell measurement report trigger extension in response to a first condition being fulfilled according to the first indication.

In some embodiments, the first condition includes the measurement result of a serving cell of the UE being below a first threshold, or a variation of the measurement result of the serving cell being above a second threshold.

In some embodiments, the processor is further configured to: enable the second configuration for multiple cell measurement report trigger extension in response to a second condition being fulfilled according to the first indication.

In some embodiments, the second condition includes a measurement result of a serving cell of the UE being above a first threshold, or a variation of the cell quality of the serving cell being less than a second threshold.

In some embodiments, initiating the measurement reporting procedure includes: initiating the measurement reporting procedure in response to a triggered non-serving cell with a best measurement result being changed according to the second indication.

In some embodiments, initiating the measurement reporting procedure includes: initiating the measurement reporting procedure in response to a status change of the measurement results of triggered non-serving cells being above a third threshold according to the second indication.

In some embodiments, initiating the measurement reporting procedure includes: initiating the measurement reporting procedure in response to a location of the UE is within the reference area according to the third indication.

Another embodiment of the present disclosure provides a BS, which includes: a processor; and a transceiver coupled with the processor, and the transceiver is configured to: transmit a first configuration for triggering a measurement reporting procedure for one or more cells at a UE, wherein the first configuration includes one of the following: a first indication associated with triggering the measurement reporting procedure at the UE when a second configuration for multiple cell measurement report trigger extension is available; a second indication associated with an update of triggered cells measurement results; or a third indication associated with a reference area of the UE; and receive a measurement report of the measurement reporting procedure.

In some embodiments, the first indication indicates the UE to trigger the measurement reporting procedure when a first cell as a first one which fulfills an entry condition of a configured measurement trigger event, wherein the measurement report of the measurement reporting procedure includes a measurement result of the first cell.

In some embodiments, the first indication indicates the UE to trigger the measurement reporting procedure periodically after the measurement reporting procedure is initiated based on the second configuration for multiple cell measurement report trigger extension.

In some embodiments, the first indication further indicates a timer for periodically initiating the measurement report.

In some embodiments, the first indication indicates the UE to disable the second configuration for multiple cell measurement report trigger extension in response to a first condition being fulfilled.

In some embodiments, the first condition includes the measurement result of a serving cell of the UE being below a first threshold, or a variation of the measurement result of the serving cell being above a second threshold.

In some embodiments, the first indication indicates the UE to enable the second configuration for multiple cell measurement report trigger extension in response to a second condition being fulfilled.

In some embodiments, the second condition includes a measurement result of a serving cell of the UE being above a first threshold, or a variation of the measurement result of the serving cell being less than a second threshold.

In some embodiments, the second indication indicates the UE to initiate the measurement reporting procedure in response to a triggered non-serving cell with a best measurement result in the cell list being changed.

In some embodiments, the second indication indicates the UE to trigger the measurement reporting procedure in response to a status change of the measurement results of triggered non-serving cells being above a third threshold.

In some embodiments, the third indication indicates the UE to trigger the measurement reporting procedure in response to a location of the UE is within the reference area.

Yet another embodiment of the present disclosure provides a method performed by a UE, which includes: receiving a first configuration for triggering a measurement reporting procedure for one or more cells, wherein the first configuration includes one of the following: a first indication associated with triggering the measurement reporting procedure when a second configuration for multiple cell measurement report trigger extension is available; a second indication associated with an update of triggered cells measurement; or a third indication associated with a reference area of the UE; and transmitting a measurement report of the measurement reporting procedure.

Still another embodiment of the present disclosure provides a method performed by a BS, which includes: transmitting a first configuration for triggering a measurement reporting procedure for one or more cells at a UE, wherein the first configuration includes one of the following: a first indication associated with triggering the measurement reporting procedure at the UE when a second configuration for multiple cell measurement report trigger extension is available; a second indication associated with a cell list of the one or more cells; or a third indication associated with an update of triggered cells measurement; and receiving a measurement report of the measurement reporting procedure.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present disclosure.

FIG. 2 illustrates a method performed by a UE for wireless communication according to a preferred embodiment of the present disclosure.

FIG. 3 illustrates a method performed by a BS for wireless communication according to a preferred embodiment of the present disclosure.

FIG. 4 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

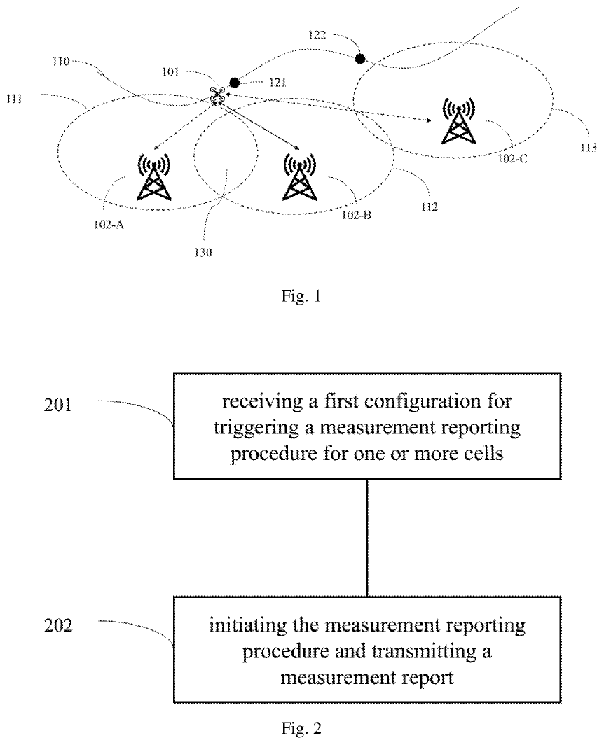

FIG. 1 illustrates a schematic diagram of a wireless communication system, i.e. an unmanned aerial system (UAS). In FIG. 1, the wireless communication system includes a UE 101, and three BSs 102 (including BS 102-A, BS 102-B, and BS-102-C, and hereinafter may be referred to as BS 102 for short). BS 102-A manages cell 111, BS 102-B manages cell 112, and BS 102-C manages cell 113, and the serving cell of UE 101 is cell 112. One cell may intersect with another cell, for example, cell 111 intersects with cell 112, and the intersection is marked by the numeral reference 130 in FIG. 1.

The UE 101 may include a UAV UE, unmanned vehicles, or other user equipment, and is referred to as UE for short in the present disclosure. The UE may communicate directly with the BS 102 via uplink (UL) communication signals. The UE may have a flight part 110, and the UE is configured to fly along this path. There might be certain points such as point 121 and point 122 along the path.

The BSs 102 may be distributed over a geographic region. In certain embodiments, each of the BSs 102 may also be referred to as an access point, an access terminal, a base, a macro cell, a Node-B, an enhanced Node B (eNB), a gNB, a Home Node-B, a relay node, or any device described using other terminology used in the art. The BSs 102 are generally parts of a radio access network that may include one or more controllers communicably coupled to one or more corresponding BSs 102.

The wireless communication system is compatible with any type of network that is capable of sending and receiving wireless communication signals. For example, the wireless communication system is compatible with a wireless communication network, a cellular telephone network, a Time Division Multiple Access (TDMA)-based network, a code division multiple access (CDMA)-based network, an orthogonal frequency division multiple access (OFDMA)-based network, an LTE network, a 3^{rd} generation partnership project (3GPP)-based network, a 3GPP 5G network, a satellite communications network, a high altitude platform network, and/or other communications networks.

In some embodiments, the wireless communication system is compatible with the 5G new radio (NR) of the 3GPP protocol, wherein the BSs 102 transmit data using an orthogonal frequency division multiplexing (OFDM) modulation scheme on the downlink and the UEs transmit data on the uplink using a discrete Fourier transform-spread-orthogonal frequency division multiplexing (DFT-S-OFDM) or a cyclic prefix-orthogonal frequency division multiplexing (CP-OFDM) scheme. More generally, the wireless communication system may implement some other open or proprietary communication protocols, for example, WiMAX, among other protocols.

In some other embodiments, the BS 102 may communicate using other communication protocols, such as the IEEE 802.11 family of wireless communication protocols. Further, in some embodiments, the BS 102 may communicate over licensed spectrums, whereas in other embodiments the BS 102 may communicate over unlicensed spectrums. The present disclosure is not intended to be limited to the implementation of any particular wireless communication system architecture or protocol. In another embodiment, the BS 102 may communicate with the UEs using 3GPP 5G protocols.

Even though a specific number of UEs and BS are depicted in FIG. 1, persons skilled in the art will recognize that any number of UEs and BSs may be included in the wireless communication system.

When the UE flies in the sky, the path loss, or line of sight (LOS) path loss between the UE and the neighbor cells may be very small. For example, as shown in FIG. 1, the path loss between UE 101 and neighbor cell 111 and the path loss between UE 101 and neighbor cell 113 are very small. Therefore, the UE may receive strong signals from many neighbor cells, and the signal transmitted from the UE may have strong interference to neighbor cells.

Since the LOS path loss between the UE and the neighbor cells is small, which may render many neighbor cells easily fulfilling the measurement report trigger condition, the UE may then trigger the measurement reporting procedure and transmit the measurement report to the BS frequently. In order to control the amount of measurement reports, a configuration for multiple cell measurement report trigger extension is applied. According to the configuration, the UE may trigger a measurement report if a number of cells fulfill the measurement report trigger condition. The event may include the following:

Event A3: the signal strength of a neighbor cell (managed by the same BS or a different BS as the serving cell) is greater than that of the serving cell.

Event A4: the signal strength of the neighbor cell (managed by the same BS or a different BS as the serving cell) is greater than a threshold value.

Event A5: the signal strength of the serving cell is less than a predefined first threshold value and the signal strength of a neighboring cell (managed by the same BS or a different BS as the serving cell) is greater than a predefined second threshold value. The first threshold value may be smaller than the second threshold value.

The configuration for multiple cell measurement report trigger extension may help the BS determine whether a UE is flying, and may also help the BS reduce the signaling overhead of measurement report.

However, the configuration for multiple cell measurement report trigger extension may introduce additional delays because this configuration may trigger the measurement report in minimum cases, and is not suitable for mobility purposes, e.g. handover, in which case latency and measured high quality neighbor cell is important for the UE.

Currently, in 3GPP document TS 36.331, the multiple cell measurement report trigger extension is as follows:
2> if the triggerType is set to event and if the corresponding reportConfig includes numberOfTriggeringCells, and if the entry condition applicable for this event, i.e. the event corresponding with the eventId of the corresponding reportConfig within VarMeasConfig, is fulfilled for one or more applicable cells for all measurements after layer 3 filtering taken during timeToTrigger defined for this event within the VarMeasConfig:
   3> If the VarMeasReportList does not include a measurement reporting entry for this measId (a first cell triggers the event):
      4> include a measurement reporting entry within the VarMeasReportList for this measId;
   3> If the number of cell(s) in the cellsTriggeredList is larger than or equal to numberOfTriggeringCells:
      4> include the concerned cell(s) in the cellsTriggeredList defined within the VarMeasReportList for this measId;
   3> else:
      4> include the concerned cell(s) in the cellsTriggeredList defined within the VarMeasReportList for this measId;
      4> If the number of cell(s) in the cellsTriggeredList is larger than or equal to numberOfTriggeringCells:
         5> set the numberOfReportsSent defined within the VarMeasReportList for this measId to 0;
         5> initiate the measurement reporting procedure, as specified in 5.5.5.

Based on the above content, it is known that: when the total number (represented by “n” for clarity) of cell(s) in the list of cells that fulfil the trigger conditions, i.e. cellsTriggeredList is larger than or equal to the configured threshold number (represented by “N” for clarity), i.e. numberOfTriggeringCells, that is, when n≥N, the concerned cell(s) is included in the list of cells.

When the total number (represented by “n” for clarity) of cell(s) in the list of cells is smaller than the configured number (represented by “N” for clarity), that is, when n<N, the concerned cell(s) is included in the list of cells. Then the updated total number of cell(s) in the list equals: n plus the total number (represented by “m”) of the concerned cell(s), i.e. n+m. If the updated total number of cell(s) in the list, i.e. n+m is larger than or equal to the configured threshold number, that is, n+m≥N, the measurement reporting procedure is initiated.

In conclusion, the measurement reporting procedure of multiple cell measurement report trigger extension is initiated only once according to the 3GPP document.

The present disclosure proposes some solutions for improving the abovementioned measurement reporting procedure of the multiple cell measurement report trigger extension to reduce the measurement report delay and reflect high quality neighbor cells.

### Solution 1

In solution 1, the UE is in a connected mode with a BS, and the UE is configured with the multiple cell measurement report trigger extension. That is, the corresponding measurement report configuration includes the threshold of total number of triggered cells, i.e. numberOfTriggeringCells.

The measurement report configuration may further include an indication, which indicates that the multiple cell measurement report trigger extension is for mobility purposes, and the indication may be a 1 bit indication. For example, the bit value of “1” of the indication indicates that the multiple cell measurement report trigger extension is for mobility purposes, while the bit value of “0” of the indication indicates that the multiple cell measurement report trigger extension is not for mobility purposes.

Specifically, the indication may indicate the UE to trigger the measurement reporting procedure when a first cell as a first one which fulfils an entry condition of a configured measurement trigger event, and the UE may transmit the measurement report to the BS. The measurement report of the measurement reporting procedure includes a measurement result of the first cell.

Alternatively, the measurement report configuration may not include the indication, rather, the BS may implicitly indicate the multiple cell measurement report trigger extension is for mobility purposes. For example, the BS may configure a corresponding parameter to enable the first cell to initiate a report.

After a UE receives the indication or the implicit indication, it may initiate the measurement reporting procedure when the first cell as the first one that fulfils an entry condition of a configured measurement trigger event. That is, when the UE detects the first cell that fulfils the entry condition of the event after layer 3 filtering during a time period, i.e. timeToTrigger, which is defined for the event, and no measurement report is included in the local maintained variable list for the first cell (in other words, there is no measurement report for a corresponding measurement ID of the first neighbor cell), the UE may initiate a measurement reporting procedure, and transmit the measurement report to the BS.

The exemplary amendments to the 3GPP specification may be as follows (the underlined features are newly proposed in the present discourse):
2> if the triggerType is set to event and if the corresponding reportConfig includes numberOfTriggeringCells and enabled mobility measurement enhancement, and if the entry condition applicable for this event, i.e. the event corresponding with the eventId of the corresponding reportConfig within VarMeasConfig, is fulfilled for one or more applicable cells for all measurements after layer 3 filtering taken during timeToTrigger defined for this event within the VarMeasConfig:
   3> If the VarMeasReportList does not include a measurement reporting entry for this measId (a first cell triggers the event):
   4> include a measurement reporting entry within the VarMeasReportList for this measId;
   4> initiate the measurement reporting procedure, as specified in 5.5.5.

### Solution 2

In solution 2, the UE is in a connected mode with a BS, and the UE is configured with the multiple cell measurement report trigger extension. That is, the corresponding measurement report configuration includes the threshold of total number of triggered cells, i.e. numberOfTriggeringCells.

The corresponding measurement report configuration may further include an indication, which indicates that the multiple cell measurement report trigger extension is for mobility purposes, and the indication may be a 1 bit indication. For example, the bit value of “1” of the indication indicates that the multiple cell measurement report trigger extension is for mobility purposes, while the bit value of “0” of the indication indicates that the multiple cell measurement report trigger extension is not for mobility purposes.

Specifically, the indication may indicate the UE to trigger the measurement reporting procedure periodically after the measurement reporting procedure is initiated based on the configuration for the multiple cell measurement report trigger extension.

Alternatively, the BS may implicitly indicate the multiple cell measurement report trigger extension is for mobility purposes by configuring the corresponding parameter to trigger the measurement reporting procedure periodically after the measurement reporting procedure is initiated.

After a UE receives the configuration, it may periodically initiate the measurement reporting procedure after the measurement report being triggered based on the multiple cell measurement report trigger extension. The period may be realized by a timer. The value of the timer may be configured by the BS, or by the network, or based on UE implementation.

For example, if the UE triggers a measurement reporting procedure when each RSRP value for the configured threshold number (i.e. numberOfTriggeringCells) of cells fulfils the configured event, such as event A3, the UE may start (or restart) the timer and initiate the measurement report procedure after the timer expires. When the triggered cell number in the local list is lower than the configured threshold number of triggered cells, i.e. numberOfTriggeringCells, the UE may stop the timer. When the triggered cell number in the local list is higher than or equal to the configured threshold number of triggered cells again, the UE may restart the timer.

The exemplary amendments to the 3GPP specification may be as follows (the underlined features are newly proposed in the present discourse):
2> if the triggerType is set to event and if the corresponding reportConfig includes numberOfTriggeringCells and enabled mobility measurement enhancement, and if the entry condition applicable for this event, i.e. the event corresponding with the eventId of the corresponding reportConfig within VarMeasConfig, is fulfilled for one or more applicable cells for all measurements after layer 3 filtering taken during timeToTrigger defined for this event within the VarMeasConfig:
   3> If the VarMeasReportList does not include a measurement reporting entry for this measId (a first cell triggers the event):
      4> include a measurement reporting entry within the VarMeasReportList for this measId;
   3> If the number of cell(s) in the cellsTriggeredList is larger than or equal to numberOfTriggeringCells:
      4> include the concerned cell(s) in the cellsTriggeredList defined within the VarMeasReportList for this measId;
      4> if the timer expires
         5> initiate the measurement reporting procedure, as specified in 5.5.5;
         5> (re)start the timer
   3> else:
      4> include the concerned cell(s) in the cellsTriggeredList defined within the VarMeasReportList for this measId;
      4> If the number of cell(s) in the cellsTriggeredList is larger than or equal to numberOfTriggeringCells:
         5> set the numberOfReportsSent defined within the VarMeasReportList for this measId to 0;
         5> initiate the measurement reporting procedure, as specified in 5.5.5;
         5> (re)start the timer
      4> Else
         5> if the timer is running
         6> stop the timer

### Solution 3

In solution 3, the UE is in a connected mode with a BS, and the UE is configured with the multiple cell measurement report trigger extension. That is, the corresponding measurement report configuration includes the threshold of total number of triggered cells, i.e. numberOfTriggeringCells.

In this solution, the BS may transmit an indication to indicate the UE to autonomously enable or disable the configuration for multiple cell measurement report trigger extension in response to a configured condition being fulfilled. The indication may be a 1 bit indication. For example, the bit value of “1” of the indication may indicate that the UE may autonomously enable or disable the configuration for multiple cell measurement report trigger extension in response to the configured condition being fulfilled, while the bit value of “0” of the indication may indicate that the UE is not allowed to autonomously disable the configuration for the multiple cell measurement report trigger extension.

The BS may also configure the condition for the UE to determine when to enable or disable the multiple cell measurement report trigger extension. In some cases, the condition may include: a measurement result of a serving cell of the UE being below a first threshold, for example, the reference signal received power (RSRP) value of the serving cell is below a first threshold, or another value that may reflect the cell quality may also apply here, such as reference signal received quality (RSRQ), or signal to interference plus noise ratio (SINR), etc. In some other cases, the condition may be: cell quality of the serving cell degrades rapidly. That is, a variation of the measurement result of the serving cell is above a second threshold. For instance, the variation of RSRP, the variation of RSRQ, or the variation of SINR, etc. In some other cases, the condition may include any combination of the above measurement results that reflects the cell quality of the serving cell. For example, at least one of the RSRP, RSRQ, and SINR is below the first threshold, and/or at least one of the variation of the RSRP, RSRQ, and SINR is above the second threshold.

After the UE receives the indication, the UE may determine whether the condition is met, and when the condition is met, the UE may enable or disable the configuration for the multiple cell measurement report trigger extension.

For example, if the indication is the RSRP of the serving cell is lower than a threshold, after receiving this indication, the UE may continuously monitor or measure the RSRP of the serving cell. When the RSRP of the serving cell is lower than the configured threshold, the UE may disable the multiple cell measurement report trigger extension. After disabling the multiple cell measurement report trigger extension, the UE may initiate the measurement reporting procedure as long as one cell fulfils the A3 event after L3 filtering during a time period, i.e. time to trigger (TTT).

The exemplary amendments to the 3GPP specification may be as follows (the underlined features are newly proposed in the present discourse):
2> if the triggerType is set to event and if the corresponding reportConfig includes numberOfTriggeringCells, and if the entry condition applicable for this event, i.e. the event corresponding with the eventId of the corresponding reportConfig within VarMeasConfig, is fulfilled for one or more applicable cells for all measurements after layer 3 filtering taken during timeToTrigger defined for this event within the VarMeasConfig:
   3> If the VarMeasReportList does not include a measurement reporting entry for this measId (a first cell triggers the event):
      4> include a measurement reporting entry within the VarMeasReportList for this measId;
   3> If the number of cell(s) in the cellsTriggeredList is larger than or equal to numberOfTriggeringCells:
      4> include the concerned cell(s) in the cellsTriggeredList defined within the VarMeasReportList for this measId;
   3> else:
      4> include the concerned cell(s) in the cellsTriggeredList defined within the VarMeasReportList for this measId;
      4> If the number of cell(s) in the cellsTriggeredList is larger than or equal to numberOfTriggeringCells:
         5> set the numberOfReportsSent defined within the VarMeasReportList for this measId to 0;
         5> initiate the measurement reporting procedure, as specified in 5.5.5;
<version 1>
   3> If a UE autonomous disable multi-cell trigger is configured, and if corresponding condition is fulfilled:
      4> include the concerned cell(s) in the cellsTriggeredList defined within the VarMeas ReportList for this measId;
         5> initiate the measurement reporting procedure, as specified in 5.5.5;
<version 2>
   3> if corresponding condition is fulfilled, the UE shall disable multi-cell trigger report, if configured.

In some other embodiments, the present disclosure proposes some solutions for triggering the measurement report.

### Solution 4

In solution 4, the UE is in a connected mode with a BS, and the UE is configured with measurement reporting trigger event for mobility purposes, for example, the above mentioned event A3, or other events. The event may include an entry condition for adding a neighbor cell to the local maintained parameter list, e.g. cellsTriggeredList.

The UE may perform the measurement of the cells, and if UE monitor that at least one neighbor cell fulfills the entry condition of event A3 after L3 filtering during TTT, the UE may add the at least one neighbor cell in the local maintained parameter list. Additionally, the UE may sort the list in descending order or in ascending order based on the measurement results of the at least one neighbor cell. For example, the UE may sort the list in descending order based on the RSRP values of the at least one neighbor cell. After sorting the list, the UE may further check whether the neighbor cell with the best measurement result (e.g. with the highest RSRP value) in the newly sorted list is changed or not compared the previous list.

If the neighbor cell with the highest RSRP value in the list has changed, the UE may initiate the measurement reporting procedure. In some embodiments, the UE may further determine the RSRP difference between the neighbor cell with the highest RSRP and the neighbor cell with the second highest RSRP, and when the RSRP difference is higher than a configured threshold, the UE may initiate the measurement reporting procedure. If the RSRP difference is equal to or lower than a configured threshold, the UE may not initiate the measurement reporting procedure.

For instance, during the measurement, the UE may have detected three neighbor cells, which are represented by A, B, and C, that fulfill the entry condition. The UE may add the three neighbor cells into the list, i.e. cellsTriggeredList. The UE then sorts the list based on the RSRP values of the neighbor cells in descending order, for example, cell A has the highest RSRP value, cell B has the second highest RSRP value, and cell C has the lowest RSRP value, accordingly, the list may be: A, B, and C.

The UE may continue performing the measurement, and may detect a new neighbor cell D that fulfills the entry condition. The UE may add the neighbor cell D to the list, and may sort the list with the new neighbor cell D. It is supposed that the neighbor cell D has the highest RSRP value, accordingly, the list may be: D, A, B, and C. In this case, the neighbor cell with the highest RSRP in the list has changed from neighbor cell A to neighbor cell D, the UE may initiate the measurement reporting procedure. If UE determines that neighbor cell A is still the cell with the highest RSRP in the list, the UE may not initiate the measurement reporting procedure.

In some other cases, during the measurement, the UE may determine that RSRP values of the three cells A, B, and C have changed, for example, the RSRP value of cell B become the highest among the RSRP values of the three neighbor cells. that is, the neighbor cell with the highest RSRP in the list is changed, from neighbor cell A to neighbor cell B. the UE may initiate the measurement reporting procedure. If UE determines that neighbor cell A is still the cell with the highest RSRP in the list, the UE may not initiate the measurement reporting procedure.

In some other cases, only when the RSRP difference between the RSRP value of cell B and that of cell A is higher than a configured threshold, the UE may initiate the measurement reporting procedure, otherwise the UE may not initiate the measurement reporting procedure.

The exemplary amendments to the 3GPP specification may be as follows (the underlined features are newly proposed in the present discourse):
if the reportType is set to eventTriggered and measurement enhancement for UAV UE mobility is enabled, and if the entry condition applicable for this event, i.e. the event corresponding with the eventId of the corresponding reportConfig within VarMeasConfig, is fulfilled for one or more applicable cells not included in the cellsTriggeredList for all measurements after layer 3 filtering taken during timeToTrigger defined for this event within the VarMeasConfig:
   3> set the numberOfReportsSent defined within the VarMeasReportList for this measId to 0;
   3> include the concerned cell(s) in the cellsTriggeredList defined within the VarMeasReportList for this measId;
   3> if useT312 is set to true in reportConfig for this event:
      4> if T310 for the corresponding SpCell is running; and
      4> if T312 is not running for corresponding SpCell:
         5> start timer T312 for the corresponding SpCell with the value of T312 configured in the corresponding measObjectNR;
   3> sorting the cells TriggeredList in decreasing order of the measurement results quantity of each entry, if the first cell is changed compared with the case before the sorting, including the first cell trigger case,
      4> (optionally) if the quantity of the first cell larger than the quantity of the second cell a configured threshold
         5> initiate the measurement reporting procedure, as specified in 5.5.5;

### Solution 5

In solution 5, the UE is in a connected mode with a BS, and the UE is configured with measurement reporting trigger event for mobility purpose, for example, the abovementioned event A3, or other events. The event may include an entry condition for adding a neighbor cell to the local maintained parameter list, e.g. cellsTriggeredList.

The UE may perform the measurement of the cells, and if UE monitor that at least one cell fulfills the entry condition of event A3 after L3 filtering during TTT, the UE may add the at least one cell in the local maintained parameter list, e.g. cellsTriggeredList. Additionally, the UE may sort the list in descending order or in ascending order of the cell quality of the at least one cell, for example, the RSRP value of the at least one cell.

When the list includes at least one cell, the UE may sort the list periodically, or sort the list after a cell is added to the list, or sort the list when a cell is removed from the list or any combination thereof. The UE may sort the list in descending order of the measurement results of each cell, and determine the status change number of the cell list.

The following events may be considered as one change number of the cell list status:
a) a new cell being add into the list;
b) a cell being removed from the list; or
c) the cell order change.

When the cell list status change number reaches a configured threshold, the UE may initiate the measurement reporting procedure.

For example, before sorting the cell list, the cell list contains cell A, cell B, and cell C in decreasing order of the corresponding measured result, for example, the measured RSRP value. In one case, a new cell is added into the list and after sorting the list, the cell list contains cell A, cell B, cell C, and cell D, then the change number is 1. In another case, a cell is removed from the list and after sorting the list, the cell list contains cell A and cell B, then the cell list status change number is 1. In the third case, the cell order is changed and after sorting the list, the cell list contains cell B, cell A, and cell C, then the cell list status change number is 2.

The UE may continue adding the cell list status change number, suppose the threshold for the list status change number is 5, then when the cell list status change number reaches to 5, the UE may initiate the measurement reporting procedure.

After transmitting the measurement report, the UE may reset the cell list status change number to zero, and restart the calculation of the cell list status change number.

### Solution 6

In solution 6, the UE is in a connected mode with a BS, and the UE may have reported a flight path to the BS, or the BS may configure the flight path to the UE. The BS may configure the measurement report based on whether an event triggering the measurement report has occurred. The event may be associated with a waypoint and/or time stamp of the reported flight path. The BS may also configure which the UE waypoints and time stamps to trigger the report. For example, according to the flight path (as 3D waypoints and associated time stamps) reported by a UE, the BS may configure the UE to trigger a measurement reporting procedure at a specific time point, at a specific waypoint, in a specific area, or at a time duration before arriving a waypoint, including the purpose of reporting on leave.

For example, as shown in FIG. 1, the flight path 110 may be reported by the UE to the BS. During the flight path 110, two points, point 121 and point 122 may be configured for triggering the measurement reporting procedure. When the UE arrives at these points, the UE may trigger the measurement reporting procedure, and transmit the measurement report to the BS. Alternatively, the area 130, which is the intersection of cell 111 and cell 112, may be configured for triggering the measurement reporting procedure. When the UE is within the area, the UE may trigger the measurement reporting procedure, and transmit the measurement report to the BS.

In another example, the UE may be configured to trigger the measurement reporting procedure at 12:00, and the UE may trigger the measurement reporting procedure at 12:00 and transmit the measurement report to the BS.

FIG. 2 illustrates a method performed by a UE for wireless communication according to some embodiments of the present disclosure. Details described in all of the foregoing embodiments of the present disclosure are applicable for the embodiments shown in FIG. 2. In some examples, the procedure may be performed by a UE, for example, UE 101 in FIG. 1.

In operation 201, the UE may receive a first configuration for triggering a measurement reporting procedure for one or more cells, wherein the first configuration includes one of the following: a first indication associated with triggering the measurement reporting procedure when a second configuration for multiple cell measurement report trigger extension is available (for example, the indication included in solution 1, solution 2, and solution 3); a second indication associated with an update of triggered cells measurement results (for example, the indication included in solution 4 and solution 5); or a third indication associated with a reference area of the UE (for example, the indication included in solution 6. In operation 202, the UE may initiate the measurement reporting procedure and transmit a measurement report.

In some embodiments, initiating the measurement reporting procedure may include initiating the measurement reporting procedure when a first cell as a first one which fulfills an entry condition of a configured measurement trigger event according to the first indication, wherein the measurement report of the measurement reporting procedure includes a measurement result of the first cell. For example, in solution 1, the UE may initiate the measurement reporting procedure when the first cell as a first one which fulfills an entry condition, such as event A3.

In some embodiments, initiating the measurement reporting procedure may include initiating the measurement reporting procedure periodically according to the first indication after the measurement reporting procedure is initiated based on the second configuration for the multiple cell measurement report trigger extension. For example, in solution 2, the UE may initiate the measurement reporting procedure after the measurement reporting procedure is initiated based on the configuration for the multiple cell measurement report trigger extension, i.e. the configuration for multiple cell measurement report trigger extension as described in the 3GPP document.

In some embodiments, initiating the measurement reporting procedure may include using a timer for periodically initiating the measurement report according to the first indication.

In some embodiments, the UE may disable the second configuration for multiple cell measurement report trigger extension in response to a first condition being fulfilled according to the first indication. For example, in solution 3, the UE may be configured with a condition, and in response to the condition being fulfilled, the UE may disable the configuration for multiple cell measurement report trigger extension for the second configuration for multiple cell measurement report trigger extension.

In some embodiments, the first condition includes the measurement result of a serving cell of the UE being below a first threshold, or a variation of the measurement result of the serving cell being above a second threshold. For example, the RSRP of the serving cell is low, or the RSRP of the serving cell is degrading rapidly.

In some embodiments, the UE may enable the second configuration for multiple cell measurement report trigger extension in response to a second condition being fulfilled according to the first indication.

In some embodiments, the second condition includes a measurement result of a serving cell of the UE being above a first threshold, or a variation of the cell quality of the serving cell being less than a second threshold. For example, the RSRP of the serving cell is low, or the RSRP of the serving cell is degrading rapidly.

In some embodiments, initiating the measurement reporting procedure may include initiating the measurement reporting procedure in response to a triggered non-serving cell with a best measurement result being changed according to the second indication. For example, in solution 4, when the neighbor cell with the highest RSRP in the list has changed from neighbor cell A to neighbor cell D, the UE may initiate the measurement reporting procedure.

In some embodiments, initiating the measurement reporting procedure may include initiating the measurement reporting procedure in response to a status change of the measurement results of triggered non-serving cells being above a third threshold according to the second indication. For example, in solution 5, suppose the threshold for the list status change number is 5, then when the cell list status change number reaches to 5, the UE may initiate the measurement reporting procedure.

In some embodiments, initiating the measurement reporting procedure may include initiating the measurement reporting procedure in response to a location of the UE is within the reference area according to the third indication. For example, as shown in FIG. 1, when the UE is within area 130, the UE may initiate the measurement reporting procedure.

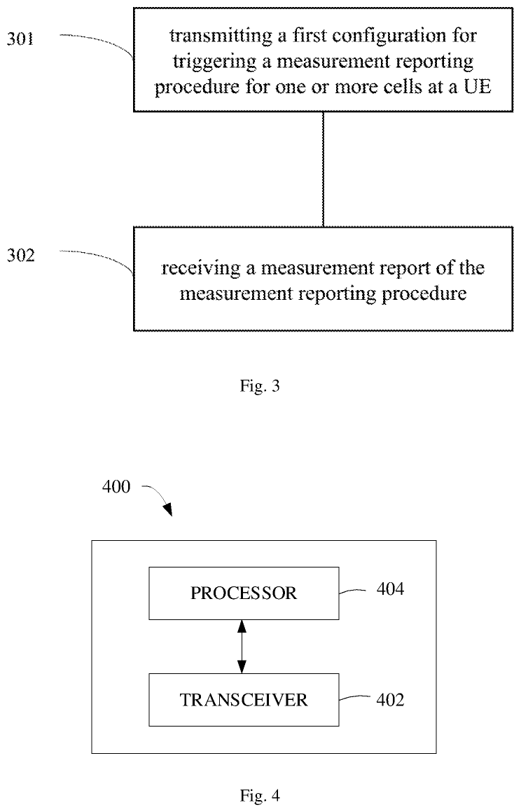

FIG. 3 illustrates a method performed by a BS for wireless communication according to some embodiments of the present disclosure. Details described in all of the foregoing embodiments of the present disclosure are applicable for the embodiments shown in FIG. 3. In some examples, the procedure may be performed by a BS, for example, BS 102-A in FIG. 1.

In operation 301, the BS may transmit a first configuration for triggering a measurement reporting procedure for one or more cells at a UE, wherein the first configuration includes one of the following: a first indication associated with triggering the measurement reporting procedure at the UE when a second configuration for multiple cell measurement report trigger extension is available; a second indication associated with an update of triggered cells measurement results; or a third indication associated with a reference area of the UE. In operation 301, the BS may receive a measurement report of the measurement reporting procedure.

FIG. 4 illustrates an exemplary simplified block diagram of an exemplary apparatus according to some embodiments of the present disclosure. As shown in FIG. 4, the apparatus 400 may include at least one processor 404 and at least one transceiver 402 coupled to the processor 404. The apparatus 400 may be a UE or a BS.

Although in this figure, elements such as the at least one transceiver 402 and processor 404 are described in the singular, the plural is contemplated unless a limitation to the singular is explicitly stated. In some embodiments of the present disclosure, the transceiver 402 may be divided into two devices, such as a receiving circuitry and a transmitting circuitry. In some embodiments of the present disclosure, the apparatus 400 may further include an input device, a memory, and/or other components.

In some embodiments of the present disclosure, the apparatus 400 may be a UE. The transceiver 402 and the processor 404 may interact with each other so as to perform the operations with respect to the UE described in FIGS. 1-3. In some embodiments of the present disclosure, the apparatus 400 may be a BS. The transceiver 402 and the processor 404 may interact with each other so as to perform the operations with respect to the BS described in FIGS. 1-3.

In some embodiments of the present disclosure, the apparatus 400 may further include at least one non-transitory computer-readable medium.

For example, in some embodiments of the present disclosure, the non-transitory computer-readable medium may have stored thereon computer-executable instructions to cause the processor 404 to implement the method with respect to the UE as described above. For example, the computer-executable instructions, when executed, cause the processor 404 interacting with transceiver 402 to perform the operations with respect to the UE described in FIGS. 1-3.

In some embodiments of the present disclosure, the non-transitory computer-readable medium may have stored thereon computer-executable instructions to cause the processor 404 to implement the method with respect to the BS as described above. For example, the computer-executable instructions, when executed, cause the processor 404 interacting with transceiver 402 to perform the operations with respect to the BS described in FIGS. 1-3.

In various embodiments, UAV hardware, firmware, and/or software may be modified, upgraded, and/or programmed to perform the functions, methods, and behaviors described herein. In some embodiments, software, hardware, and/or firmware may be created to interface with pre-existing UAV interfaces. In other embodiments, modifications to one or more portions of a UAV may be made to accomplish the described systems and methods. Hardware, firmware, and/or software may also be used in conjunction with a UAV to extend or replace its capabilities to implement any of the embodiments described herein.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE), comprising:
at least one memory; and
at least one processor coupled with the at least one memory and configured to cause the UE to:
receive a first configuration for triggering a measurement reporting procedure for one or more cells, wherein the first configuration includes one of the following:
a first indication associated with triggering the measurement reporting procedure when a second configuration for multiple cell measurement report trigger extension is available;
a second indication associated with an update of triggered cells measurement results; or a third indication associated with a reference area of the UE; and
initiate the measurement reporting procedure and transmit a measurement report.

2. The UE of claim 1, wherein the at least one processor is configured to cause the UE to initiate the measurement reporting procedure when a first cell as a first one which fulfills an entry condition of a configured measurement trigger event according to the first indication, wherein the measurement report of the measurement reporting procedure includes a measurement result of the first cell.

3. The UE of claim 1, wherein the at least one processor is configured to cause the UE to initiate the measurement reporting procedure periodically according to the first indication after the measurement reporting procedure is initiated based on the second configuration for multiple cell measurement report trigger extension.

4. The UE of claim 3, wherein the at least one processor is configured to cause the UE to use a timer for periodically initiating the measurement report according to the first indication.

5. The UE of claim 1, wherein the at least one processor is configured to cause the UE to disable the second configuration for multiple cell measurement report trigger extension in response to a first condition being fulfilled according to the first indication.

6. The UE of claim 5, wherein the first condition includes the measurement result of a serving cell of the UE being below a first threshold, or a variation of the measurement result of the serving cell being above a second threshold.

7. The UE of claim 1, wherein the at least one processor is configured to cause the UE to enable the second configuration for multiple cell measurement report trigger extension in response to a second condition being fulfilled according to the first indication.

8. The UE of claim 7, wherein the second condition includes a measurement result of a serving cell of the UE being above a first threshold, or a variation of a cell quality of the serving cell being less than a second threshold.

9. The UE of claim 1, wherein the at least one processor is configured to cause the UE to the measurement reporting procedure in response to a triggered non-serving cell with a best measurement result being changed according to the second indication.

10. The UE of claim 1, wherein the at least one processor is configured to cause the UE to initiate the measurement reporting procedure in response to a status change of the measurement results of triggered non-serving cells being above a third threshold according to the second indication.

11. The UE of claim 1, wherein the at least one processor is configured to cause the UE to initiate the measurement reporting procedure in response to a location of the UE is within the reference area according to the third indication.

12. A base station, comprising:
at least one memory; and
at least one processor coupled with the at least one memory and configured to cause the base station to:
transmit a first configuration for triggering a measurement reporting procedure for one or more cells at a user equipment (UE), wherein the first configuration includes one of the following:
a first indication associated with triggering the measurement reporting procedure at the UE when a second configuration for multiple cell measurement report trigger extension is available;
a second indication associated with an update of triggered cells measurement results; or
a third indication associated with a reference area of the UE; and
receive a measurement report of the measurement reporting procedure.

13. The base station of claim 12, wherein the first indication indicates the UE to trigger the measurement reporting procedure when a first cell as a first one which fulfills an entry condition of a configured measurement trigger event, wherein the measurement report of the measurement reporting procedure includes a measurement result of the first cell.

14. The base station of claim 12, wherein the first indication indicates the UE to trigger the measurement reporting procedure periodically after the measurement reporting procedure is initiated based on the second configuration for multiple cell measurement report trigger extension.

15. A method performed by a user equipment (UE), the method comprising:
receiving a first configuration for triggering a measurement reporting procedure for one or more cells, wherein the first configuration includes one of the following:
a first indication associated with triggering the measurement reporting procedure when a second configuration for multiple cell measurement report trigger extension is available;
a second indication associated with an update of triggered cells measurement; or
a third indication associated with a reference area of the UE; and
transmitting a measurement report of the measurement reporting procedure.

16. A processor for wireless communication, comprising:
at least one controller coupled with at least one memory and configured to cause the processor to:
receive a first configuration for triggering a measurement reporting procedure for one or more cells, wherein the first configuration includes one of the following:
a first indication associated with triggering the measurement reporting procedure when a second configuration for multiple cell measurement report trigger extension is available;
a second indication associated with an update of triggered cells measurement results; or
a third indication associated with a reference area of a user equipment (UE); and
initiate the measurement reporting procedure and transmit a measurement report.

17. The processor of claim 16, wherein the at least one controller is configured to cause the processor to initiate the measurement reporting procedure when a first cell as a first one which fulfills an entry condition of a configured measurement trigger event according to the first indication, wherein the measurement report of the measurement reporting procedure includes a measurement result of the first cell.

18. The processor of claim 16, wherein the at least one controller is configured to cause the processor to initiate the measurement reporting procedure periodically according to the first indication after the measurement reporting procedure is initiated based on the second configuration for multiple cell measurement report trigger extension.

19. The processor of claim 18, wherein the at least one controller is configured to cause the processor to use a timer for periodically initiating the measurement report according to the first indication.

20. The processor of claim 16, wherein the at least one controller is configured to cause the processor to disable the second configuration for multiple cell measurement report trigger extension in response to a first condition being fulfilled according to the first indication.
